(19) United States
(12) Patent Application Publication
(10) Pub. No.: US 2007/0217553 A1
(43) Pub. Date: Sep. 20, 2007

(54) DYNAMIC SELECTION OF AN OPTIMUM SIGNAL FROM A PLURALITY OF SIGNAL SOURCES

(75) Inventors: Roger A. Brown, Quakertown, PA (US); John R. Carlson, Lansdale, PA (US); Stephen J. Nicolo, Perkasie, PA (US); Gary A. Thom, Lansdale, PA (US)

Correspondence Address: WILLIAM H. EILBERG, THREE BALA PLAZA, SUITE 501 WEST, BALA CYNWYD, PA, 19004, US

(73) Assignee: DELTA INFORMATION SYSTEMS, INC., Horsham, PA (US)

(21) Appl. No.: 11/684,233

(22) Filed: Mar. 9, 2007

Related U.S. Application Data
(60) Provisional application No. 60/743,526, filed on Mar. 17, 2006.

(51) Int. Cl. H04B 1/10

(52) U.S. Cl. 375/349

(57) ABSTRACT

An optimum signal is assembled from a set of data streams originating from a transmitter. Corresponding bits of the data streams are compared, and for each set of corresponding bits, an output bit is selected based on a majority vote of the data streams. If a majority vote does not yield a result, an output bit can be selected from a default stream, or from a stream which yielded a preceding output bit. Data streams having a signal quality below a predetermined limit are disregarded for purposes of conducting the majority vote. The output stream therefore includes bits taken from different data streams and different times, and has a quality greater than is achievable by any one of the original data streams.

### CROSS-REFERENCE TO PRIOR APPLICATION

Priority is claimed from U.S. provisional patent application Ser. No. 60/743,526, filed Mar. 17, 2006, the entire disclosure of which is incorporated by reference herein.

### BACKGROUND OF THE INVENTION

The present invention relates to the field of data transmission, and provides a method and apparatus for dynamically selecting an optimum signal from a plurality of signal sources.

In particular, in one embodiment of the present invention, data originating from a single transmitter are received by a plurality of receivers positioned in disparate locations.

One example of the use of the present invention is in the testing of an aircraft or missile. The aircraft may transmit a continuous stream of data, the data being taken from various instruments mounted on the aircraft. The signal from the aircraft is received at a plurality of receiving stations, located on the ground, and positioned in widely scattered locations. If the aircraft is expected to traverse a great distance during the course of the test, the receiving stations may be spaced apart by hundreds of miles. In the most general case, some or all of the receiving stations may be moving, as they could be mounted on ground vehicles.

In theory, each receiver on the ground will receive exactly the same signal from the aircraft. In practice, what is received at one station will differ from what is received at another. Not only does the signal from the aircraft arrive at the receiving stations at slightly different times, but other factors, such as physical obstructions, electrical noise, and signal reflections, cause the quality of the signals detected at each receiver to vary considerably. Thus, a given receiver might produce a good signal at certain times, and a poor signal at other times. At any given moment, one subset of the receivers might produce a good signal, and another subset might produce a poor signal. Due to the difficulty of predicting the effects of noise, obstructions, signal reflections, or intentional jamming, it is virtually impossible to know, in advance, which stations will produce the best signal at any given moment.

To solve the problem of signal degradation, it has been known, in the prior art, to select a “best” signal by detecting a known pattern in the data stream, and counting the errors in that pattern to determine the overall quality of the stream. This solution will not work for encrypted data streams, unless the entire stream is first decrypted. It also has the disadvantage of being dependent on the existence of the known pattern.

It has also been proposed to produce a high quality signal by using prior knowledge about the relative position of the transmitter and receivers, in switching from one receiver to another. The latter method clearly does not work if one does not know, in advance, where the aircraft (or other transmitter) will be, and it also risks loss of significant amounts of data before a switch can be made. Moreover, knowledge of the position of the aircraft does not imply knowledge of all the sources of noise and other signal degradations that can occur.

The present invention solves the above-described problems, by producing a signal of enhanced quality, by automatically and dynamically selecting among several signals produced by a plurality of receiving stations.

The present invention overcomes the problem of data loss sustained at the time that one switches from one receiver to another, whether that loss is due to the switching process itself or due to noise bursts. Such error bursts typically occur at the worst possible times, when critical data are required, such as when the aircraft or other vehicle is performing a critical maneuver.

The present invention also works well with encrypted data, and does not require a decryption step. The latter is an important feature, because encryption is prevalent in many communication systems.

### SUMMARY OF THE INVENTION

The present invention comprises a method and apparatus for automatically and dynamically selecting among a plurality of signal sources, to derive a signal which has greater overall quality than that of any one of the signal sources.

In its most basic form, the invention resides in measuring the quality of a plurality of data streams, and, for each corresponding bit in each stream, selecting an output bit determined by a majority “vote” among the best of the various streams. A given data stream is “entitled” to a vote if its quality is determined to be good. The result is an output stream of bits, the output stream comprising the best signal available, for any given moment in time, of all of the signals from the various sources. Thus, the quality of the output stream is, in general, different from any of the original streams, and better than that of any one of the original streams.

To accomplish the above, a plurality of data streams are first delivered, in parallel, to a module that measures the quality of each stream, and generates signals representative of such quality. In a preferred embodiment, the quality is measured both on a long-term basis (i.e. by examining a larger number of bits) and a short-term basis (i.e. by examining a smaller number of bits), and the results are transmitted through the system together with the original data.

Next, the signals enter a phase alignment module, which aligns the phases of the various signals, such that the bits of all of the signals are synchronized with the same clock signal. The latter clock signal is preferably derived from the best of the various data streams.

The signals then enter a data alignment section, in which the signals are aligned in time, by introduction of suitable delays in one or more of the signals.

Finally, the signals enter a majority vote module. In this module, the corresponding bits of the various streams are compared, and an output bit is generated based on a majority vote among the various streams. The voting rules are such that a stream does not receive a vote unless it is determined to be of sufficiently high quality. Thus, for a given bit position, if the qualified streams show more zeros than ones, the output bit is zero, and if the qualified streams show more ones than zeros, the output bit is one. In the event of a “tie” vote, the system may default either to the “primary” stream, i.e. the stream having the highest long-term quality, or to the stream from which the previous output bit was obtained.

Thus, the output stream is obtained by, in effect, rapidly switching from one source stream to another, and generating a bit of the output stream according to a virtually instantaneous majority vote among the source streams. The output stream therefore contains the “best” bits available. In general, the output stream has a higher quality than would be obtainable from any of the source streams.

The present invention therefore has the primary object of providing a method and apparatus for automatically and dynamically selecting among a plurality of source data streams, to produce an output stream having high signal quality.

The invention has the further object of automatically selecting the “best” signal from a plurality of disparate signal sources.

The invention has the further object of facilitating the testing of an aircraft, or the like, which transmits data to a plurality of disparate receivers.

The invention has the further object of providing a method and apparatus as described above, wherein the invention works equally well regardless of whether the data are encrypted.

The invention has the further object of automatically assembling an output signal from a plurality of nominally identical source signals, wherein the output signal has, in general, a higher quality than any of the source signals.

The invention has the further object of providing a method and apparatus as described above, wherein it is possible to switch rapidly among a plurality of signal sources without losing data.

The invention has the further object of providing a method and apparatus as described above, wherein the output stream is essentially produced in real time.

The invention has the further object of improving the testing of an aircraft, or the like, by compensating for signal fluctuations caused by relative movement among the aircraft and a plurality of receivers.

The reader skilled in the art will recognize other objects and advantages of the present invention, from the following brief description of the drawings, the detailed description of the invention, and the appended claims.

### BRIEF DESCRIPTION OF THE DRAWINGS

FIG. 1 provides a diagram illustrating the use of the present invention in testing an aircraft, the figure showing the aircraft transmitting data to a plurality of receiving stations.

FIG. 2 provides a block diagram illustrating the major components of the apparatus of the present invention.

FIG. 3 provides a series of graphs illustrating a technique for quantifying signal quality, as used in block A of FIG. 2.

FIG. 4A provides a pulse diagram showing a plurality of data streams, used in the present invention, before such streams have been aligned by phase or by time.

FIG. 4B provides a pulse diagram similar to that of FIG. 4A, but in which the streams have been aligned in phase, but not in time, by the apparatus of block B of FIG. 2.

FIG. 5 provides a pulse diagram showing a plurality of data streams, used in the present invention, wherein the streams have been aligned both by phase and by time, using the apparatus of block C of FIG. 2.

FIG. 6 provides a pulse diagram, illustrating the construction of an output stream, according to the present invention, using a majority voting technique, as contained in block D of FIG. 2.

### DETAILED DESCRIPTION OF THE INVENTION

The present invention comprises a method and apparatus for automatically and dynamically selecting a signal from among a plurality of signal sources, so as to derive an output signal that is, in general, better than any one of such sources.

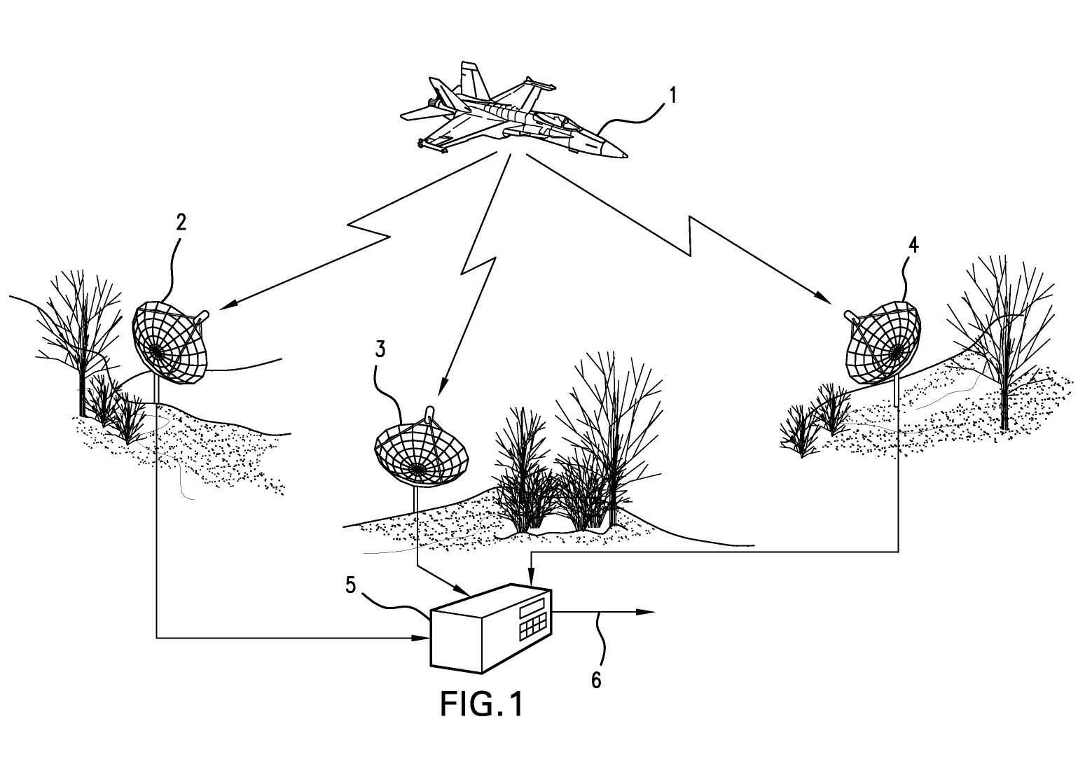

A typical use of the present invention is illustrated in FIG. 1. In this example, an aircraft 1 being tested flies over a wide territory. A plurality of receiving stations (2, 3, 4) are positioned in various locations within the territory. The aircraft transmits a stream of data, which could comprise instantaneous and continuous measurements taken by various instruments on the aircraft, or other data. At any given moment, the data stream may be received by some or all of the receiving stations, but the quality of the signal at each station may vary. Electrical noise, obstructions due to terrain, or signal reflections may degrade the signal from time to time. At a particular point in time, the signal at one receiver may be better than the signal at another receiver, or vice versa. To assemble a signal of the highest possible quality, it is necessary to switch instantly from one receiver to another, in some sequence which is unpredictable in advance.

FIG. 1 shows source selector unit 5, into which the various data streams are conveyed, and which selects an output stream 6 comprising the best possible data, and having a higher quality than would be available from any one of the other streams.

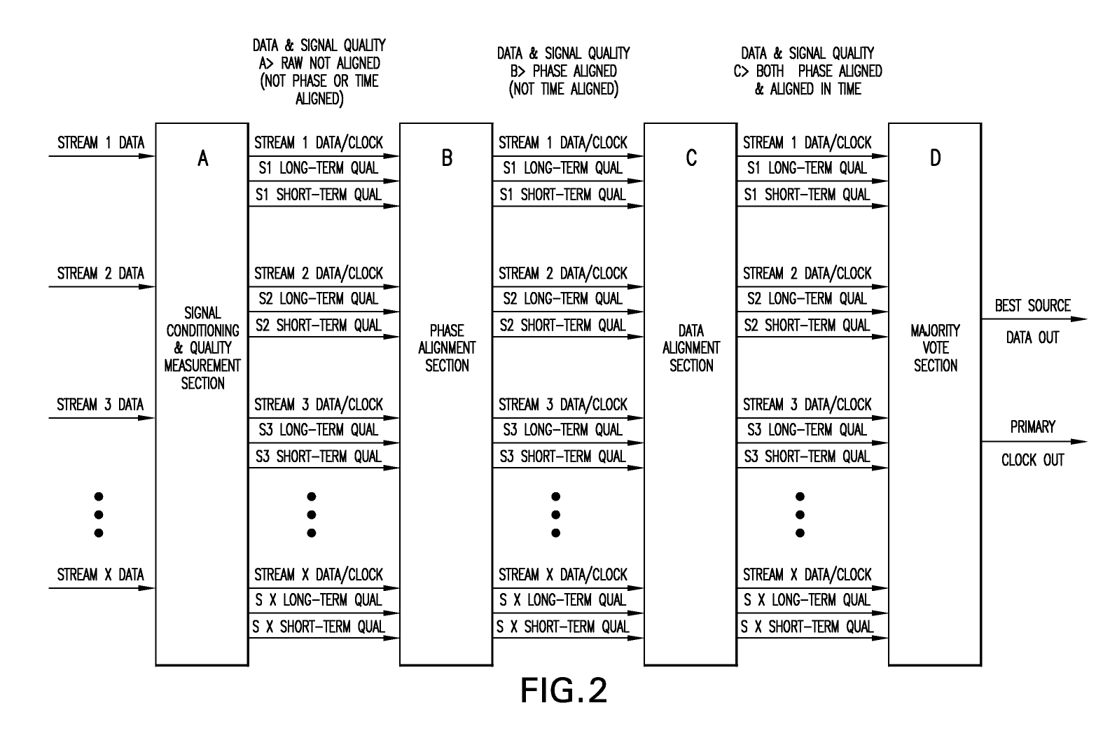

FIG. 2 provides a block diagram showing the major components of the source selector unit of the present invention. In block A, the signals from the various sources are conditioned and their quality is measured. In block B, the phases of the various signals are aligned. In block C, the various signals are aligned in time. In block D, the signals are compared, and an output signal is generated according to a “majority voting” technique to be described below.

The functions of each block will be discussed in detail, in the following paragraphs.

Block A: Signal Conditioning and Signal Quality Measurement

Block A of FIG. 2 provides signal conditioning and signal quality measurement. A primary component of the signal conditioning step is the production of a clock signal, associated with the data stream. The clock signal can be produced by any of various methods known in the art. Thus, each data stream can be associated with its own clock signal.

Signal quality is affected by such factors as noise, interference, signal jitter, and signal distortion. Signal quality is preferably measured both on a long-term basis (i.e. the measurement being taken over a large number of bits) and on a short-term basis (i.e. the measurement taken over a small number of bits). The measurements are preferably taken with the aid of a phase lock loop, locked to the input signal, to obtain samples of the input taken at the nominal peak and the zero crossing points. In the following examples, the nominal peak is designated as I (for “Inphase”) and the zero crossing is designated as Q (for “Quadrature”). The ratio of the averaged magnitudes of I and Q provide measures of signal degradation.

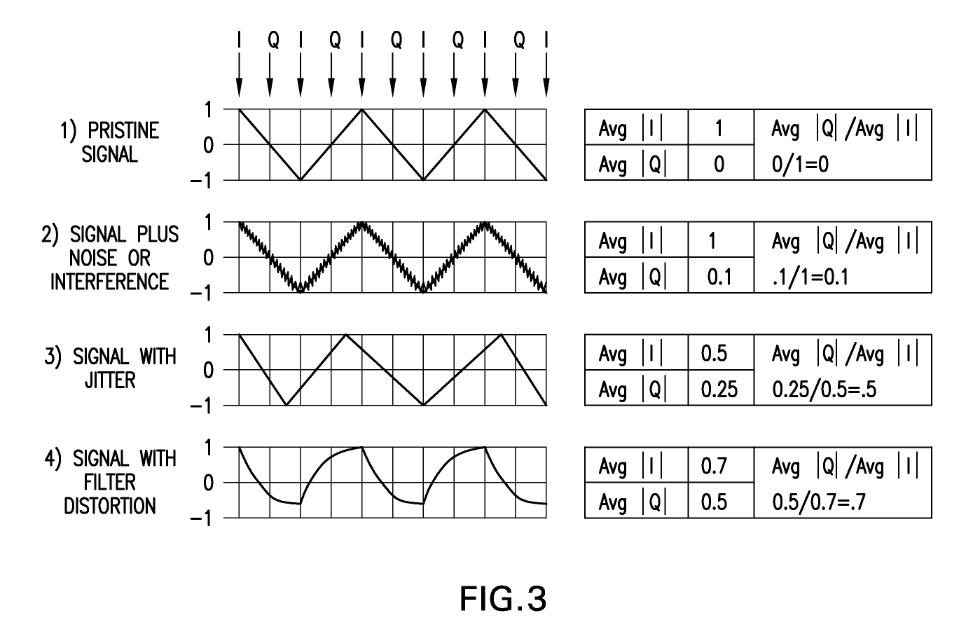

FIG. 3 illustrates the measurement of signal quality for the cases of 1) a pristine signal, 2) a signal having noise or interference, 3) a signal having jitter, and 4) a signal with filter distortion. For each case, the input signal, the averaged I and Q magnitudes, and the ratio of the averaged I and Q magnitudes, are shown. The latter ratio provides a quantitative measurement of the signal degradation.

The short-term average may be made using a relatively small number of samples before and after the current sample. The long-term average may be made using a larger number, such as several hundreds, of samples. The short-term quality signal provides a quick indication of quality that is more responsive to changing conditions but statistically less accurate. The long-term quality signal gives a more accurate but more sluggish quality indication.

The long-term signal may be represented as a sequence of binary numbers, each having, for example, 6 to 8 bits. Suppose that the binary number is chosen to have 8 bits. Then the value of each long-term signal quality measurement can be expressed as an integer from 0 to 255. The ratio of the average magnitude of Q to the average magnitude of I is then represented as an integer within this range. A result of zero represents a perfect signal, and a result of 255 represents a signal having the poorest quality. If the ratio of Q/I were one-half, the result would be encoded as 128 (i.e. approximately one-half of 255). These measurements could be translated into signal-to-noise ratios, or other similar indicators, using known techniques.

In the first example of FIG. 3, showing a pristine signal, the average value of the magnitude of I is always one, and the average value of the magnitude of Q is always zero. Thus, the ratio of the magnitude of Q to the magnitude of I is always zero. The zero result means that there is no signal degradation, and the signal is perfect. This result would be encoded as a binary number equal to zero.

In the second example of FIG. 3, the signal has some noise or interference. In this example, the average value of the nominal peak I is still one, but the average value of the magnitude of Q is 0.1, due to the noise. The ratio of the magnitudes of I and Q is thus 0.1. On an eight-bit scale, this value could be represented as a binary 26 (i.e. 0.1×256).

In the third example of FIG. 3, the signal has jitter, and the average magnitude of I is 0.5, while the average magnitude of Q is 0.25. Thus, the ratio of the magnitudes of I and Q is 0.5, which would be represented as 128 (0.5×256).

In the fourth example of FIG. 3, the signal has filter distortion, and the average magnitude of I is 0.7, while the average magnitude of Q is 0.5. Thus, the ratio of the magnitudes of I and Q is about 0.7, which would be represented as 179 (0.7×256).

Note that, in general, the ratio of the magnitudes of I and Q ranges from zero, for a perfect signal, to one, for a worst-case signal.

As suggested above, the range of 0-1 can be expressed as an integer in the range of 0-255. Expressing the quality in this way makes it possible to store the quality figure as an 8-bit binary number, which facilitates calculations.

The above example is only one way of measuring and representing the signal quality. Other quantification schemes could be used, within the scope of the present invention.

Regardless of the manner in which the quality measurement is stored, the above technique shows how signal quality can be reduced to a number. Because the signal quality has been quantified, the relative quality of two signals can be directly compared, simply by comparing two numbers. In the methodology to be discussed later, these quality measurements will be used to determine a quality “threshold”. Thus, for example, an input signal would not be used for purposes of determining an output stream unless the input signal has a quality exceeding a predetermined threshold.

The relationship between the long-term and short-term quality measurements will be explained in more detail later. In brief, the long-term quality measurement comprises an initial, coarse filter, to eliminate streams that have such poor quality that they should not be used at all. The short-term measurement is used as an integral part of the “majority voting” technique, to be described below. In brief, a signal whose short-term quality has fallen to an unacceptable level will temporarily lose its right to vote.

The signal quality information may be augmented with additional information, when available, such as phase lock loop lock status, signal loss (the magnitude of the signal falling below a minimum value), error correction statistics, frame lock and error information, and correlation error information.

The measurement of signal quality is substantially unaffected by the contents of the data, other than the transition density (the number of one-to-zero or zero-to-one transitions in the data stream, per unit of time). In general, a higher transition density produces a better measurement of signal quality. For this reason, the present invention works especially well with encrypted data, because such data generally have a high transition density.

Block B: Phase Alignment

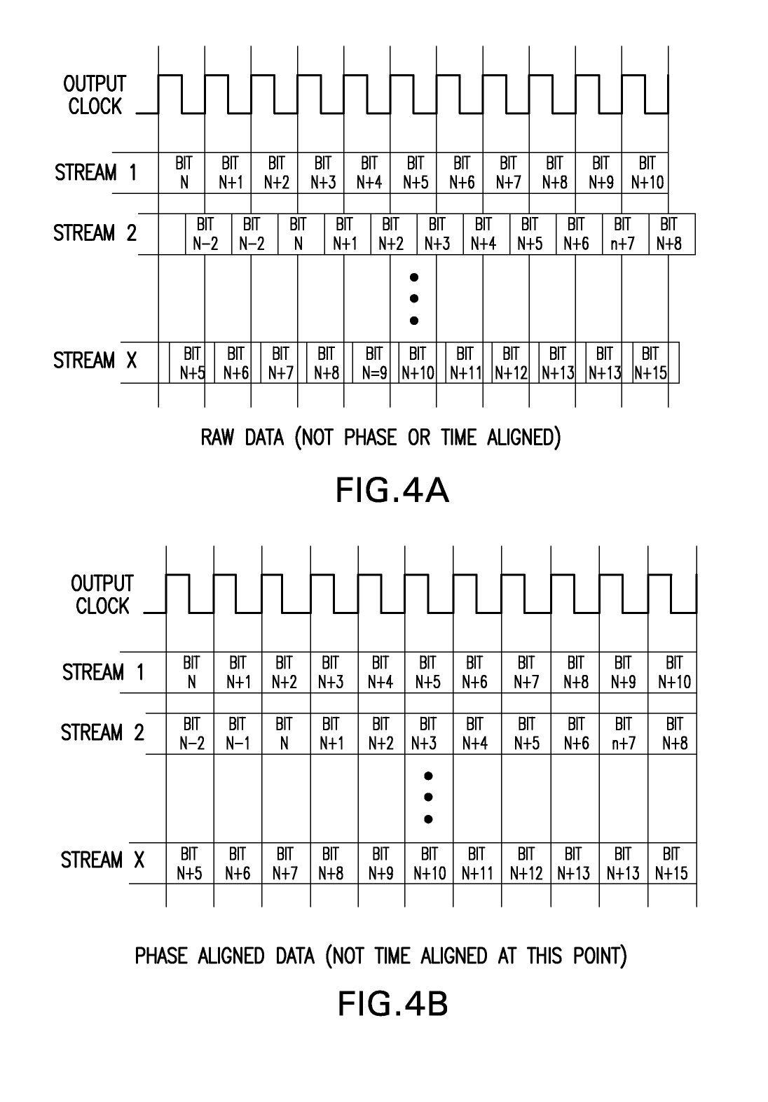

Block B of FIG. 2 represents the alignment of the phases of the various signals. FIG. 4A illustrates a hypothetical set of signals entering block B, each signal being represented as a stream of bits. Each bit is associated with an integer, which is directly related to the time associated with a particular bit. As shown in FIG. 4A, the incoming data are aligned neither by phase nor by time. These are thus “raw” data.

As noted above, in Block A, a clock signal was constructed for each data stream. The system must choose one of these clock signals as the “primary” clock. In the present invention, the primary clock is defined as the clock signal associated with the data stream found to be of highest quality, on a long-term basis. The primary clock signal is also designated the “output” clock. Thus, in FIG. 4A, the “output clock” signal is the clock signal associated with the data stream deemed to be of the highest quality.

In the example given in FIG. 4A, the output clock is the clock associated with Stream 1. But, in general, the output clock could be taken from any of the other signals, whichever is deemed to be of highest quality.

To align the phases of the signals, the phase alignment module will add small amounts of delay, using a phase lock loop, to Streams 2 through X, until the signals are switching synchronously with the data transitions and output clock of Stream 1, which is the primary (highest quality) stream in this example. The construction of a phase lock loop is within the level of skill in the art, and does not itself form part of the present invention.

FIG. 4B illustrates the data streams after they are phase aligned. Note that all data bits switch synchronously with the output clock. Note however that even though the streams are all switching synchronously at this point, the data are still not aligned by time. This lack of time-alignment is apparent from the bit labels. For example, FIG. 4B shows bit N of Stream 1 aligned with bit N−2 of Stream 2 and bit N+5 of Stream X. To achieve seamless switching from stream to stream, on a bit-by-bit basis, it is necessary to align the signals also by time, as will be described below.

Block C: Time Alignment

The various data streams are aligned, by time, in block C of FIG. 2. In general, each of the data streams may be subject to random time delays, due to transmission distance, or to different equipment delays. In order to obtain meaningful results from the method of the present invention, it is necessary to align the data streams in time.

The data streams can be aligned by time, in the following manner. Once the phases of the data streams have been corrected, as indicated in FIG. 4B, the data are stored in memory. The system then grabs a sequence of data bits from the primary data stream. The number of bits in such sequence could be 128, or some other number. The larger the number of bits, the greater the accuracy of the process, but the greater the amount of computation time required. As before, the primary stream is defined as the data stream having the highest quality of all the streams under consideration.

Next, for each of the other data streams, the stored sequence is compared to various sequences, of comparable length, taken from the other streams. For example, a 128-bit sequence from Stream 1 is compared with each of several 128-bit sequences from Stream 2, wherein each sequence used from Stream 2 is displaced by one bit from the next.

In performing each comparison, the system computes the value of a correlation function. The comparison which yields the highest correlation dictates the alignment of bits between Stream 1 and Stream 2. Since all of the streams originate from the same source, a high correlation between relatively long sequences of bits in two different data streams indicates that such streams are properly aligned in time. A low correlation means that the sequences are not aligned in time.

In effect, the present method comprises storing a sample sequence from the primary stream, and correlating that sequence with comparable sequences from another stream, each of said comparable sequences having a different time alignment relative to the stored sample. For example, the stored 128-bit sequence taken from Stream 1, in the vicinity of bit N of Stream 1, could be correlated with 128-bit sequences taken from Stream 2, where the sequences from Stream 2 begin at bit positions N−5, N−4, N−3, N−2, N−1, N, N+1, N+2, N+3, N+4, N+5, and so forth. Of the comparisons implied above, only one is likely to yield a good match (a high value of the correlation function).

The above described technique can be practiced with any data correlation function, and the invention is not limited to use with a particular function. Various correlation functions are known in the art.

When the correlations have been established, the system records its results using memory pointers, and the system then delays or advances each of the streams, as appropriate, so as to align the streams in time.

The above technique clearly requires that the system “know” about the details of a signal, a few bits into the future, and a few bits into the past. Therefore, to perform the method, it is necessary to introduce some delay into the final output stream. In practice, however, the time needed to perform the necessary calculations is small relative to the time scale for which measurements of the aircraft are desired.

In using the technique described above, the data need not be completely free of errors in order to be correlated and aligned. Also, since the bits grabbed from the primary stream do not have to be known or programmed ahead of time, the process will work whether or not the data are encrypted.

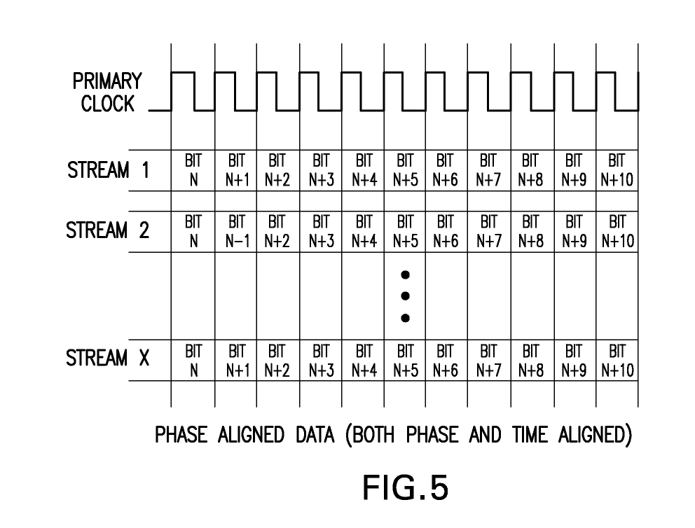

When the alignment process is complete, the streams are aligned in time, and the memory data bit pointers for each of the candidate streams are locked so that they sequentially increment through the individual stream delay memories and point to the corresponding bit location in each stream in step with the corresponding bit locations of the primary stream. Thus, as shown in FIG. 5, when the pointer for the primary stream (Stream 1) is pointing to bit N, the memory pointers for Streams 2 through X would also point to bit N.

The system can be programmed with a maximum delay length, i.e. the length of the stream data buffers, based on the maximum possible path delay between any of the input sources. Such a maximum delay length is useful in keeping the system latency to a minimum.

FIG. 5 thus illustrates the data streams as they exit block C, i.e. after they have been aligned both by phase and by time. All of the streams now switch synchronously with the primary clock (i.e. they are phase aligned), and the same bit locations are lined up in time (i.e. they are time aligned). The first vertical set of bit positions in each stream (Streams 1 through X), have bit N in the first bit position, as all streams are aligned in time. The combination of phase alignment and time alignment makes it feasible to achieve seamless switching from stream to stream on a bit-by-bit basis.

Block D: Majority Voting

Block D of FIG. 2 comprises the most important part of the present invention, as it is the block in which the output signal is assembled.

Block D represents a majority voting module which includes a means for comparing corresponding bits from each of the data streams entering the module, and a means for selecting a bit according to a majority vote among the data streams under consideration. Block D also represents a means for assembling an output bit stream comprising bits selected according to the majority vote. Further details of the process are as follows.

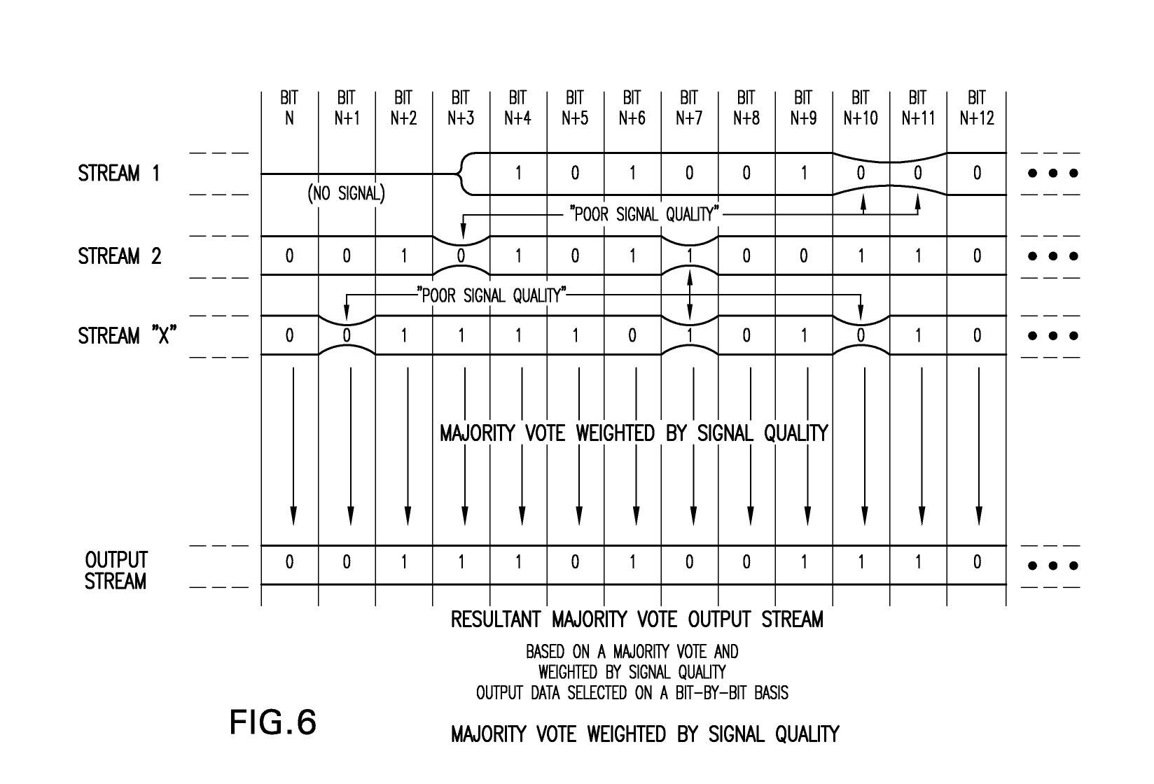

As explained above, the signal quality for each stream is measured on a long-term basis and a short-term basis. The long-term measurement is used as a coarse screening criterion; if the long-term quality of a given signal does not exceed a predetermined level, that signal is disregarded in assembling the output signal. Thus, in FIG. 6, which lists Streams 1 through X, it is assumed that the streams whose quality falls below the predetermined cutoff are not included within Streams 1 through X.

In the example represented in FIG. 6, the ellipsis between Stream 2 and Stream X has been omitted. Thus enables FIG. 6 to depict a simplified example wherein there are only three high-quality streams, namely Stream 1, Stream 2, and Stream X. But, in the more general case, there would be more data streams.

In brief, the algorithm applied in block D of FIG. 2, and symbolized in FIG. 6, operates as follows. The various candidate streams, all of which are deemed to have sufficient long-term quality, have previously been aligned in phase and time. For each bit position (i.e. each moment in time), the system evaluates the corresponding bit in each candidate stream (zero or one), and chooses the output bit according to a “majority vote” of the candidate streams.

A majority vote means that the output bit is determined by which value is more prevalent among the qualified streams. If, for the bit position under consideration, more qualified streams contain a one than a zero, the output bit will be one. If more qualified streams contain a zero than a one, the output bit will be zero.

If a stream has no signal, at a particular bit position, or if a bit in a particular signal is in a location of low short-term signal quality (i.e. signal quality below a predetermined threshold), that stream loses its vote (and is therefore ignored) for that particular bit.

The operation of the algorithm is further explained by the following detailed description of the example represented in FIG. 6.

The data streams are represented as Streams 1 through X, and are aligned in phase and in time. Thus, bit N, where N is an integer, occurs at the same time for all of these streams. Note also that, as explained above, it is assumed that streams having a long-term signal quality below the desired threshold have been removed from consideration. Therefore, Streams 1 through X are all assumed to have adequate long-term signal quality.

Because the signals are aligned in phase and time, it is feasible, and meaningful, to consider each bit, for each of the various streams. The details are as follows.

1. Bit Location N

In the column representing bit N, Stream 1 has no signal. Thus, for bit N, there are only two streams having adequate long-term signal quality, namely Stream 2 and Stream X. In this case, both Streams 2 and X have a good short-term signal quality and both have a ZERO in that bit location. That is, both streams “vote” for ZERO. The output is then ZERO.

2. Bit Location N+1

In the column representing bit N+1, Stream 1 still has no signal. Stream 2 has a good short-term signal quality with a value of ZERO. Stream X has a poor short-term signal quality with a value of ZERO. (The concave borders surrounding a bit are intended to symbolize poor short-term signal quality of that bit.) The system therefore discards the bit from the stream having the poor quality signal (Stream X), and will select the bit from Stream 2. Thus, the output stream contains a ZERO in this bit position.

3. Bit Location N+2

In the column representing bit N+2, Stream 1 still has no signal. Both Streams 2 and X have a good short-term signal quality and both have a ONE in that bit location. That is, both Streams 2 and X “vote” for ONE. The output is therefore ONE.

4. Bit Location N+3

In the column representing bit N+3, Stream 1 still has no signal. Stream 2 has a poor short-term signal quality with a value of ZERO. Stream X has a good short-term signal quality with a value of ONE. The system therefore disregards the stream having the poor short-term signal quality (Stream 2). Stream X is the only stream having a vote. The output will therefore be a ONE in that bit location.

5. Bit Location N+4

In the column representing bit N+4, all three of Streams 1, 2, and X have good short-term quality signals, and all have a ONE in this bit location. All three streams “vote” for ONE. The output bit will therefore be ONE.

6. Bit Location N+5

In the column representing bit N+5, all three of Streams 1, 2, and X have good short-term quality signals. Streams 1 and 2 have a ZERO in this bit position, and Stream X has a ONE. The output bit is based on a majority vote of the three signals, and is therefore a ZERO.

7. Bit Location N+6

In the column representing bit N+6, all three of Streams 1, 2, and X have good short-term quality signals. Streams 1 and 2 have the value ONE and Stream X has the value ZERO. A majority vote of the three streams yields an output bit of ONE.

8. Bit Location N+7

In the column representing bit N+7, Stream 1 has good short-term quality and Streams 2 and X have poor short-term quality. Therefore, the system disregards Streams 2 and X, leaving only Stream 1. Stream 1 is the only stream having a vote. Therefore, the output bit is ZERO.

9. Bit Location N+8

The algorithm uses the same logic as for bit N+4, but since the three streams have ZERO for this bit position, the output bit is ZERO.

10. Bit Location N+9

All three signals have good short-term quality. A majority vote of the three signals yields an output bit of ONE.

11. Bit Location N+10

Streams 1 and X have poor short-term quality, and Stream 2 is the only stream having good short-term quality. The output bit is determined solely by Stream 2, and is therefore ONE.

12. Bit Location N+11

Stream 1 has a poor short-term signal quality, and is therefore disregarded. Streams 2 and X both have good short-term quality, and both have a ONE for this bit position. Both Streams 2 and X “vote” for ONE. The output bit is therefore ONE.

13. Bit Location N+12

All three streams have good short-term signal quality, and all three streams have a ZERO in this bit position. The output bit is therefore ZERO.

In some cases, a majority vote among the various streams does not yield a result. This lack of a valid result could occur if there is a “tie” vote, or if all voting streams have poor short-term signal quality, or an absence of a signal bit entirely, for the bit being voted. A “tie” means that, of the voting streams, there is an equal number of votes for both ONE and ZERO.

When a majority vote is not possible, the system solves the problem as follows:

1. The system can select the output bit based on the corresponding bit in the “primary” signal. As explained above, the stream having the highest long-term quality is deemed the “primary” stream. The identity of the primary stream may change, from moment to moment. But since there is always a primary stream, it can be used to supply a bit by default.

2. Alternatively, the system can select the output bit from the last stream from which a bit was selected. For example, if the previous output bit came from Stream 2, the lack of a majority in determining the next bit could cause the system to use, as the output bit, the next bit from Stream 2. This alternative relies on the assumption that the stream that produced the best data for the previous bit will produce the best data for the next bit. This is usually, but not always, a reasonable assumption.

3. An additional means of distinguishing among the candidate streams is based on the measurement of short-term quality. If short-term quality is represented as a binary number having more than one bit, it is possible to assign various levels of short-term quality to a given stream. Thus, in the absence of a majority, the system can select an output bit from the stream having the highest short-term quality. The latter technique is not feasible if the short-term quality is recorded as a single bit (either good or bad quality), because it would then not be possible to distinguish among varying degrees of quality. This technique is not foolproof, because it is statistically possible that all of the streams could momentarily have poor short-term quality. In the latter case, the system can default to either of the alternatives described in the preceding paragraphs.

To obtain the full benefit of the method described above, it is preferable to use three or more data streams. However, significant benefits can be obtained with the use of as few as two streams. As explained above, with two streams, it is still possible to choose the stream having the better signal quality, and thereby produce an output signal that is better than either of the input signals. The system is preferably programmed such that, when a third stream becomes available, the system automatically uses the majority voting technique, as soon as possible. If the system reverts to a condition wherein there are only two valid streams, the system can use the above techniques to select an output.

Even the use of as few as three data streams yields a substantial performance improvement over the prior art, of the order of three times the square of the error rate. Thus, if each stream has an error rate of 10⁻⁶, the output error rate will be as small as about 3×10⁻¹².

The present invention has the important advantage that it enables switching of signal sources without causing an interruption in the data stream. Thus, it is possible to continue processing the stream after the source has been switched, without loss of data.

In some situations, where the receivers are located in a remote area, the signals may be sent to a separate unit, located far from the receivers, for processing. That is, the unit 5 of FIG. 1 may, in practice, be located far away from the receivers. In such cases, it may be desirable to provide a remote encapsulation unit. The encapsulation unit, located at one of the remote sites, encapsulates the data, along with signal quality information. The digital stream may then be transmitted to a central processor by land lines, or microwave links, or other means, and the data and quality information can be extracted and used by the algorithms described above. The system of the present invention could also be programmed to process a combination of local and remote (encapsulated) data streams.

In situations where an encapsulation unit cannot be placed at a remote site, the digital data can be sent to a central processor without signal quality information. In this mode, the digital data from the remote site is routed to the system of the present invention at the central location. Candidate streams are identified at the central processor, based on how many errors are counted in the data correlation process, and/or based on other quality measurements as described with respect to block A. Such other quality measurements could also include phase lock loop status, and degree of signal loss.

The present invention is not limited to the specific example discussed above, namely the testing of an aircraft or missile. The invention can be used in many applications in which a signal is received by disparate stations, and in which it is necessary to construct a “best” signal from the various received signals.

The above description has disclosed the preferred embodiments for implementing the functions represented in blocks A, B, C, and D. However, it should be understood that other methods of performing the same functions could be implemented, fully within the scope of the invention.

For example, in block A, the determination of signal quality could be performed in many different ways. There are many possible schemes for measuring and quantifying the quality of a signal. As long as such schemes yield a numerical value representative of signal quality, they could be used with the present invention.

Similarly, techniques other than those described above could be used to align the data streams by phase and by time. As noted above, different correlation functions could be used to perform the time alignment. It is possible to devise other time alignment mechanisms which yield equivalent results.

It is also possible to modify the majority voting scheme itself. As noted above, the rules for majority voting must include “default” provisions in the event of a tie, or other failure to produce a result. Various such default provisions are possible, as explained above, and all should be deemed within the scope of the present invention.

The reader skilled in the art will recognize still further modifications that may be made to the present invention. Such modifications should be considered within the spirit and scope of the following claims.

What is claimed is:

1. A method for selecting an optimum signal from a plurality of data streams, comprising:
a) comparing bits from each of a plurality of data streams, each bit corresponding to a same moment in time, and
b) selecting an output bit according to a majority vote among said plurality of data streams,
c) repeating steps (a) and (b) for subsequent bits of said plurality of data streams, wherein repeated performance of step (b) yields an output bit stream comprising an optimum signal.

2. The method of claim 1, wherein step (a) includes the step of disregarding bits from any data stream deemed to have insufficient signal quality at said moment in time.

3. The method of claim 1, further comprising determining a primary data stream according to which stream has a greatest signal quality, and wherein step (b) includes the step of selecting the output bit from the primary stream if a vote among said plurality of data streams fails to yield a result.

4. The method of claim 1, wherein step (b) includes the step of selecting the output bit from a data stream which provided a previous output bit, if a vote among said plurality of data streams fails to yield a result.

5. The method of claim 1, further comprising selecting the plurality of data streams to originate from a single transmitter.

6. The method of claim 1, further comprising determining, for each data stream, a long-term quality measurement, and performing steps (a) and (b) while disregarding any data stream having insufficient long-term quality.

7. A method of selecting an optimum signal from a plurality of data streams, comprising:
a) measuring quality of each of a plurality of data streams, and generating signals indicative of instantaneous quality of each of said streams,
b) aligning said data streams by phase,
c) aligning said data streams by time,
d) comparing corresponding bits from each of said phase and time-aligned data streams, the comparing step being performed only for streams having a quality above a predetermined threshold, and
e) selecting a sequence of output bits according to a majority vote among said plurality of data streams, so as to yield an output bit stream comprising an optimum signal.

8. The method of claim 7, wherein step (a) includes measuring a short-term quality and a long-term quality of each of said data streams, and generating separate signals indicative of short-term and long-term quality, and wherein the predetermined threshold of step (d) relates to the measurement of long-term quality.

9. The method of claim 8, wherein step (e) also comprises disregarding a bit from a stream having an insufficient short-term quality.

10. The method of claim 7, further comprising determining a primary data stream according to which stream has a greatest signal quality, and wherein step (e) includes the step of selecting an output bit from the primary stream if a vote among said plurality of data streams fails to yield a result.

11. The method of claim 7, wherein step (e) includes the step of selecting the output bit from a data stream which provided a previous output bit, if a vote among said plurality of data streams fails to yield a result.

12. The method of claim 7, further comprising selecting the plurality of data streams to originate from a single transmitter.

13. Apparatus for selecting an optimum signal from a plurality of data streams, comprising a majority voting module, the module being connected to receive a plurality of parallel data streams originating from a transmitter,
wherein the majority voting module comprises:
a) means for comparing corresponding bits from each of said plurality of data streams and for selecting an output bit according to a majority vote among said plurality of data streams, and
b) means for assembling an output bit stream comprising bits selected in the comparing means.

14. The apparatus of claim 13, wherein the data streams include a information indicative of signal quality, and wherein the comparing means includes means for disregarding bits from any data stream deemed to have insufficient signal quality at a given moment in time.

15. The apparatus of claim 13, wherein the selecting means includes means for defaulting to a primary data stream, determined according to signal quality, if a vote among said plurality of data streams fails to yield a result.

16. The apparatus of claim 13, wherein the selecting means includes means for defaulting to a data stream which provided a previous output bit, if a vote among said plurality of data streams fails to yield a result.

17. Apparatus for selecting an optimum signal from a plurality of data streams, comprising:
a) a signal conditioning and quality measurement module, connected to receive a plurality of parallel data streams originating from a transmitter, the signal conditioning and quality measurement module including means for generating at least one signal indicative of quality of each of said data streams,
b) a phase alignment module, connected to receive said data streams exiting the signal conditioning and quality measurement module, for aligning phases of the data streams with a common clock signal,
c) a time alignment module, connected to receive said data streams exiting the phase alignment module, for aligning times of the data streams, and
d) a majority voting module, connected to receive said data streams exiting the time alignment module, the majority voting module comprising means for comparing corresponding bits from each of said plurality of data streams and for selecting an output bit according to a majority vote among said plurality of data streams, and means for assembling an output bit stream comprising bits selected in the comparing means.

18. The apparatus of claim 17, wherein the signal conditioning and quality measurement module includes means for generating signals indicative of long-term quality and short-term quality corresponding to each of said data streams.

19. A method of automatically and dynamically selecting a best signal from a plurality of data streams, comprising:
a) dynamically selecting a plurality of data streams having a signal quality above a predetermined threshold,
b) comparing corresponding bits of said selected plurality of said data streams,
c) generating an output bit according to a majority vote among said plurality of data streams, and
d) repeating steps (a) through (c) to derive a sequence of output bits comprising an output stream.

20. The method of claim 19, further comprising determining a short-term signal quality for each of the streams being compared in step (b), and disregarding bits from streams having a short-term quality below a predetermined limit for purposes of step (b).
